(19) United States
(12) Patent Application Publication
(10) Pub. No.: US 2025/0182164 A1
(43) Pub. Date: Jun. 5, 2025

(54) INFORMATION PROCESSING DEVICE, INFORMATION PROCESSING METHOD, AND INFORMATION PROCESSING SYSTEM

(71) Applicant: Sharp NEC Display Solutions, Ltd., Tokyo (JP)

(72) Inventor: Taku MARUTA, Tokyo (JP)

(21) Appl. No.: 19/048,081

(22) Filed: Feb. 7, 2025

Related U.S. Application Data
(63) Continuation of application No. PCT/JP2022/031203, filed on Aug. 18, 2022.

(51) Int. Cl. G06Q 30/0251; G06T 7/70; G06V 10/764; G06V 40/16

(52) U.S. Cl. CPC G06Q 30/0269; G06T 7/70; G06V 10/764; G06V 40/178; G06T 2207/30201

(57) ABSTRACT

Provided is an information processing device in which, in a case that at least a first person and a second person are included in a captured image, a second classification is selected when performing a first determination that involves determining that track record of a first advertisement which is an advertisement associated with a first classification determined by a determination unit with respect to an attribute of the first person exceeds a first reference value which is a reference value associated with a first classification and a second determination that involves determining that track record of a second advertisement which is an advertisement associated with the second classification determined by the determination unit with respect to an attribute of the second person does not exceed a second reference value which is a reference value associated with the second classification.

### TECHNICAL FIELD

The present invention relates to an information processing device, an information processing method, and an information processing system.

### BACKGROUND ART

Research and development are being conducted on technology for displaying advertisements on display devices.

In connection with this, there is known an information processing device including: a required display count acquisition unit that acquires required display count information relating to the number of times predetermined content data is to be displayed on a predetermined display device within a displayable period of the predetermined content data; a display performance count acquisition unit that acquires display performance count information relating to display performance count of the predetermined content data displayed on the predetermined display device from the start of a displayable period to a current point in time; a scheduled display count determination unit that determines a scheduled display count of the predetermined content data to be displayed on the predetermined display device during any period after the current point in time within the displayable period on the basis of the displayable period, the required display count information, and the display performance count information; a display time slot acquisition unit that acquires display time slot information relating to a time slot in which the predetermined content data is able to be displayed on the predetermined display device; and a display start time determination unit that determines a display start time at which the content data is displayed on the predetermined display device on the basis of the scheduled display count and the display time slot information (see Patent Document 1).

### Citation List

### Patent Document

### Patent Document 1

Japanese Unexamined Patent Application, First Publication No. 2010-087836

### SUMMARY OF INVENTION

### Technical Problem

Here, the information processing device disclosed in Patent Document 1 can prevent only specific content data from being displayed on the display device. That is, the information processing device can prevent an increase in display performance (such as, for example, cumulative display count, display proportion, or cumulative display time) on the display device from being biased toward the specific content data. However, the information processing device may cause the display device to display content data which is not appropriate for the attribute of a viewer who views the content data displayed on the display device. That is, it has been difficult for information processing devices to both prevent an increase in display performance from being biased toward the specific content data and display content data appropriate for the attribute of a viewer.

The present invention was contrived in view of such circumstances, and an object thereof is to provide an information processing device, an information processing method, and an information processing system that make it possible to prevent an increase in display performance from being biased toward a specific advertisement and to display an advertisement according to the attribute of a viewer on a display device.

### Solution to Problem

According to an aspect of the present invention, there is provided an information processing device including: an acquisition unit that acquires a captured image obtained by capturing an image of an image capturing region including a position at which a display screen of a display device is visible; a storage unit that stores a reference value associated with each of a plurality of classifications determined in advance for an attribute of a viewer of an advertisement displayed on the display screen; a determination unit that determines which of the plurality of classifications an attribute of a person included in the captured image falls under; a selection unit that selects any of the plurality of classifications on the basis of at least display performance of the advertisement, for example, track record of the advertisement displayed on the display screen and a determination result of the determination unit; and a display control unit that causes the display screen to display the advertisement associated with the classification selected by the selection unit, wherein, in a case that at least a first person and a second person are included in the captured image, the selection unit selects a second classification when performing a first determination that involves determining that display performance, for example, track record of a first advertisement which is the advertisement associated with a first classification determined by the determination unit with respect to an attribute of the first person exceeds a first reference value which is the reference value associated with the first classification, and a second determination that involves determining that display performance, for example, track record of a second advertisement which is the advertisement associated with the second classification determined by the determination unit with respect to an attribute of the second person does not exceed a second reference value which is the reference value associated with the second classification.

According to an aspect of the present invention, there is provided an information processing method including: an acquisition step of acquiring a captured image obtained by capturing an image of an image capturing region including a position at which a display screen of a display device is visible; a determination unit determining which of a plurality of classifications determined in advance an attribute of a person included in the captured image falls under, for an attribute of a viewer of an advertisement displayed on the display screen; a selection step of selecting any of the plurality of classifications on the basis of at least display performance of the advertisement, for example, track record of the advertisement displayed on the display screen and a determination result of the determination unit; and a display control step of causing the display screen to display the advertisement associated with the classification selected in the selection step, wherein, in a case that at least a first person and a second person are included in the captured image, the selection step includes selecting a second classification when performing a first determination that involves determining that display performance, for example, track record of a first advertisement which is the advertisement associated with a first classification determined by the determination unit with respect to an attribute of the first person exceeds a first reference value which is the reference value associated with the first classification among reference values associated with each of the plurality of classifications, and a second determination that involves determining that display performance, for example, track record of a second advertisement which is the advertisement associated with the second classification determined by the determination unit with respect to an attribute of the second person does not exceed a second reference value which is the reference value associated with the second classification.

According to an aspect of the present invention, there is provided an information processing system including: an image capturing unit that captures an image of an image capturing region including a position at which a display screen of a display device is visible; and an information processing device, wherein the information processing device includes an acquisition unit that acquires an image captured by the image capturing unit, a storage unit that stores a reference value associated with each of a plurality of classifications determined in advance for an attribute of a viewer of an advertisement displayed on the display screen, a determination unit that determines which of the plurality of classifications an attribute of a person included in the captured image falls under, a selection unit that selects any of the plurality of classifications on the basis of at least display performance of the advertisement, for example, track record of the advertisement displayed on the display screen and a determination result of the determination unit, and a display control unit that causes the display screen to display the advertisement associated with the classification selected by the selection unit, and in a case that at least a first person and a second person are included in the captured image, the selection unit selects a second classification when performing a first determination that involves determining that display performance, for example, track record of a first advertisement which is the advertisement associated with a first classification determined by the determination unit with respect to an attribute of the first person exceeds a first reference value which is the reference value associated with the first classification, and a second determination that involves determining that display performance, for example, track record of a second advertisement which is the advertisement associated with the second classification determined by the determination unit with respect to an attribute of the second person does not exceed a second reference value which is the reference value associated with the second classification.

### Advantageous Effects of Invention

According to the present invention, it is possible to prevent an increase in display performance, for example, track record from being biased toward a specific advertisement and to display an advertisement according to the attribute of a viewer on a display device.

### BRIEF DESCRIPTION OF DRAWINGS

FIG. 1 is a diagram illustrating an example of a configuration of an information processing system 1.

FIG. 2 is a diagram illustrating an example of a hardware configuration of an information processing device 30.

FIG. 3 is a diagram illustrating an example of a functional configuration of the information processing device 30.

FIG. 4 is a diagram illustrating an example of a flow of processing in which the information processing device 30 acquires aggregation results of the attributes of each of a plurality of persons imaged by an image capturing unit 20 in a first time slot within a target period.

FIG. 5 is a diagram illustrating an example of a flow of processing in which the information processing device 30 determines a reference value in the first time slot on the basis of person identification information.

FIG. 6 is a diagram illustrating an example of a flow of processing in which the information processing device 30 causes a display device 10 to display an advertisement in the first time slot within an advertisement display period.

FIG. 7 is a diagram illustrating an example of a state in which two persons are located within an image capturing region RA.

### DESCRIPTION OF EMBODIMENTS

### Embodiment

Hereinafter, an embodiment of the present invention will be described with reference to the accompanying drawings.

### Overview of Information Processing System

First, an overview of an information processing system according to the present embodiment will be described.

An information processing system according to the present embodiment includes an image capturing unit and an information processing device. The image capturing unit captures an image of an image capturing region including a position at which the display screen of a display device is visible. The information processing device includes an acquisition unit, a storage unit, a determination unit, a selection unit, and a display control unit. The acquisition unit acquires an image captured by the image capturing unit. The storage unit stores a reference value associated with each of a plurality of classifications determined in advance for an attribute of a viewer of an advertisement displayed on the display screen. The determination unit determines which of the plurality of classifications an attribute of a person included in a captured image falls under. The selection unit selects any of the plurality of classifications on the basis of at least the display performance of the advertisement, for example, track record of the advertisement displayed on the display screen and the determination result of the determination unit. The display control unit causes the display screen to display an advertisement associated with the classification selected by the selection unit. In a case that at least a first person and a second person are included in the captured image, the selection unit selects a second classification when performing a first determination that involves determining that the display performance, for example, track record of a first advertisement which is the advertisement associated with a first classification determined by the determination unit with respect to an attribute of the first person exceeds a first reference value which is the reference value associated with the first classification, and a second determination that involves determining that the display performance, for example, track record of a second advertisement which is the advertisement associated with the second classification determined by the determination unit with respect to an attribute of the second person does not exceed a second reference value which is the reference value associated with the second classification.

This makes it possible for the information processing system according to embodiment and the information processing device included in the information processing system to prevent an increase in display performance, for example, track record from being biased toward a specific advertisement, and to display an advertisement according to an attribute of the viewer on the display device.

Hereinafter, the configuration of the information processing system according to an embodiment, the configuration of the information processing device included in the information processing system, and processing performed by the information processing device will be described in detail.

### Configuration of Information Processing System

Hereinafter, the configuration of the information processing system according to the embodiment will be described using an information processing system 1 as an example of the information processing system according to the embodiment.

Meanwhile, as an example, a case where the display performance, for example, track record of an advertisement is the display proportion of an advertisement will be described below. The details of the display proportion of an advertisement will be described later. Meanwhile, the display performance, for example, track record of an advertisement may be the cumulative number of advertisement display times, may be the cumulative advertisement display time, or may be any other type of value indicating the display performance of the advertisement, for example, track record of the advertisement displayed on the display screen. In addition, as an example, a case where an advertisement is composed of a moving image will be described below. In the following description, for convenience of description, a moving image constituting a certain advertisement will be referred to as a moving image of the advertisement. Meanwhile, an advertisement may be composed of both a moving image and sound, may be composed of a still image, may be composed of both a still image and sound, or may be composed of sound.

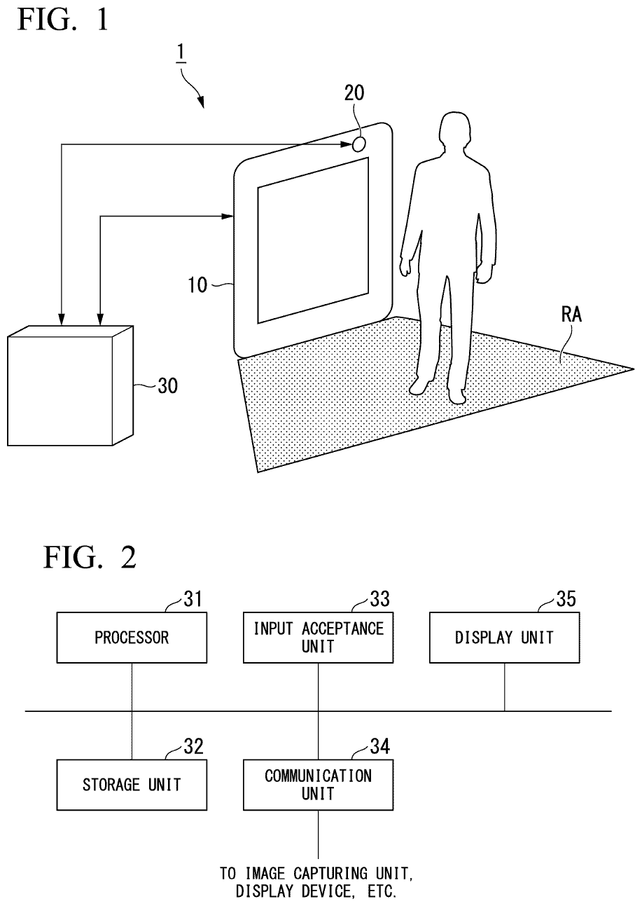

FIG. 1 is a diagram illustrating an example of a configuration of an information processing system 1.

The information processing system 1 displays an advertisement within an advertisement display period determined in advance. The advertisement display period is, for example, one week, but may alternatively be a period shorter than one week, or may be a period longer than one week. In addition, the information processing system 1 captures an image of a viewer who views an advertisement within an advertisement display period, and detects an attribute of the viewer on the basis of the captured image. The information processing system 1 then selects an advertisement according to the detected attribute from among a plurality of advertisements within an advertisement display period, and displays the selected advertisement. This makes it possible for the information processing system 1 to display an advertisement according to the viewer's attribute on the display device. As a result, the information processing system 1 can improve the sales promotion effect of the advertisement within the advertisement display period.

Here, the information processing system 1 selects an advertisement according to the detected attribute from among the plurality of advertisements on the basis of the display performance, for example, track record of a respective one of the plurality of advertisements and a reference value determined in advance for the display performance, for example, track record of a respective one of the plurality of advertisements. This makes it possible for the information processing system 1 to preferentially select an advertisement of which the display performance, for example, track record does not exceed the reference value from among the plurality of advertisements. In order to realize this, this reference value is determined in advance for each time slot, and is determined so that there is no bias in the display performance, for example, track record of a respective one of the plurality of advertisements. This makes it possible for the information processing system 1 to prevent an increase in display performance, for example, track record from being biased toward a specific advertisement in each time slot within the advertisement display period. Meanwhile, the reference value may be a common value for all time slots instead of a configuration determined in advance for each time slot.

The information processing system 1 includes, for example, a display device 10, an image capturing unit 20, and an information processing device 30. Meanwhile, in addition to the display device 10, the image capturing unit 20, and the information processing device 30, the information processing system 1 may be configured to include other members, other devices, and the like. In addition, the information processing system 1 may be configured not to include the display device 10. In this case, the information processing system 1 is communicably connected to an external display device. In addition, the information processing system 1 may be configured not to include the image capturing unit 20. In this case, the information processing system 1 is communicably connected to an external image capturing unit.

The display device 10 is a display device including a display panel such as, for example, a liquid crystal display panel or an organic electroluminescence (EL) display panel as the display screen of the display device 10. The display device 10 is communicably connected to the information processing device 30 through wireless or wired means. The display device 10 acquires an advertisement which is output from the information processing device 30. The display device 10 displays the advertisement acquired from the information processing device 30 on the display screen. Meanwhile, the display device 10 may be configured to include a speaker, or may be configured not to include a speaker. For example, in a case that the advertisement is composed of both a moving image and sound, the display device 10 includes a speaker.

The image capturing unit 20 is, for example, a camera equipped with a charge coupled device (CCD), a complementary metal oxide semiconductor (CMOS), or the like as an imaging element that converts focused light into an electrical signal. The image capturing unit 20 is provided at a position where it can capture an image of an image capturing region RA including a position at which the display screen of the display device 10 is visible. In the example shown in FIG. 1, the image capturing unit 20 is configured integrally with the display device 10 and is provided at a position above the display screen on the surface of the display device 10 on which the display screen is provided. Meanwhile, the image capturing unit 20 may be configured separately from the display device 10. Here, the hatched region in FIG. 1 shows an example of the image capturing region RA. The image capturing unit 20 may be configured to capture a still image of a range that can be captured by the image capturing unit 20, or may be configured to capture a moving image of the range. Hereinafter, as an example, a case where the image capturing unit 20 captures a moving image of the range will be described. The image capturing unit 20 is communicably connected to the information processing device 30 through wireless or wired means. The image capturing unit 20 sequentially outputs the frames of the moving image captured by the image capturing unit 20 to the information processing device 30 as captured images.

The information processing device 30 is, for example, an information processing device such as a notebook personal computer (PC), a desktop PC, a workstation, a tablet PC, a multi-functional mobile phone terminal (smartphone), or a personal digital assistant (PDA), but there is no limitation thereto.

The information processing device 30 specifies the above-described advertisement display period in accordance with the accepted operation. The advertisement display period is, for example, one week. Meanwhile, the advertisement display period may be a period shorter than one week, or may be a period longer than one week. In addition, the advertisement display period may be a period determined in advance.

The information processing device 30 performs an advertisement display process to be described below within the specified advertisement display period.

The information processing device 30 acquires an image captured by the image capturing unit 20 from the image capturing unit 20 every time a predetermined sampling period elapses. Each time the captured image is acquired, the information processing device 30 determines the number of persons included in the acquired captured image.

In a case that it is determined that the number of persons included in the acquired captured image is one (that is, in a case that it is determined that the number of persons located within the image capturing region RA is one), the information processing device 30 determines which of a plurality of classifications determined in advance the attribute of the person included in the captured image falls under, for the attribute of a viewer of an advertisement displayed on the display screen of the display device 10. In the following description, for convenience of description, this determination will be referred to as a classification determination. In addition, in the following description, for convenience of description, the classification obtained as a result of the classification determination will be referred to as a target classification. In addition, hereinafter, as an example, a case where the plurality of classifications are four classifications, that is, classifications X1 to X4 to be described below, will be described. These four classifications are as follows.
Classification X1: Men in their 20s to 50s
Classification X2: Women in their 20s to 50s
Classification X3: Men and women in their 60s and older
Classification X4: Men and women up to their teens

In this way, these four classifications are classifications based on both age and sex. Meanwhile, the plurality of classifications may be configured to include other classifications instead of some or all of these four classifications, or in addition to some or all of these four classifications. In addition, these four classifications may be classifications based on any one of age and sex. In addition, these four classifications may be classifications based on both age and sex as well as different types of attributes.

In addition, advertisements different from each other are associated with each of these four classifications. Consequently, in the following description, for convenience of description, the advertisement associated with the classification X1 will be referred to as an advertisement C1. The advertisement C1 is an advertisement which is estimated to have a sales promotion effect when viewed by a person with an attribute falling under the classification X1 (that is, an advertisement appropriate for a person with an attribute falling under the classification X1). In addition, in the following description, for convenience of description, the advertisement associated with the classification X2 will be referred to as an advertisement C2. The advertisement C2 is an advertisement which is estimated to have a sales promotion effect when viewed by a person with an attribute falling under the classification X2 (that is, an advertisement appropriate for a person with an attribute falling under the classification X2). In addition, in the following description, for convenience of description, the advertisement associated with the classification X3 will be referred to as an advertisement C3. The advertisement C3 is an advertisement which is estimated to have a sales promotion effect when viewed by a person with an attribute falling under the classification X3 (that is, an advertisement appropriate for a person with an attribute falling under the classification X3). In addition, in the following description, for convenience of description, the advertisement associated with the classification X4 will be referred to as an advertisement C4. The advertisement C4 is an advertisement which is estimated to have a sales promotion effect when viewed by a person with an attribute falling under the classification X4 (that is, an advertisement appropriate for a person with an attribute falling under the classification X4). In addition, in the following description, for convenience of description, among the four advertisements C1 to C4, the advertisement associated with the target classification selected by the information processing device 30 will be referred to as a target advertisement.

After the target classification is selected, the information processing device 30 outputs the target advertisement associated with the selected target classification to the display device 10, and causes the display device 10 to display the target advertisement.

On the other hand, in a case that it is determine that the number of persons included in the acquired captured image is N (that is, in a case that it is determined that the number of persons located within the image capturing region RA is N), the information processing device 30 orders these N persons on the basis of a permutation rule determined in advance. Here, N may be any integer insofar as it is equal to or greater than 2. The permutation rule involves, for example, ordering N persons in the order of their proximity to the display device 10. In the following description, for convenience of description, the n-th person out of the N persons ordered will be referred to as the n-th person. In this case, the n-th person is a person whose image is captured by the image capturing unit 20 at a position closer to the display device 10 than the (n+1)-th person. Here, n is any integer equal to or greater than 1 and equal to or less than N. Meanwhile, the permutation rule may be to randomly order the N persons, may be to order the N persons in the order of distance from the display device 10, may be to order the N persons in descending order of the degree to which their faces are directed toward the display device 10, or may be any other rule capable of ordering the N persons. In addition, the permutation rule may be a combination of these rules. In this case, the permutation rule may be, for example, to order the N persons in the order of their proximity to the display device 10 and the degree to which their faces are directed toward the display device 10, or the like. After the N persons are ordered on the basis of the permutation rule, the information processing device 30 performs the above-described classification determination one by one from the first person to the N-th person. The information processing device 30 then performs a reference value decision every time such a classification determination is performed. The reference value decision is a decision as to whether the current display performance, for example, track record of the target advertisement associated with the target classification obtained as a result of the classification determination exceeds the reference value for the display performance, for example, track record.

Here, in the reference value decision, the information processing device 30 specifies the time slot the including the current time. Hereinafter, as an example, a case where the 24 hours of each day included in the advertisement display period are divided into four time slots: a first time slot from 00:00 to 08:59, a second time slot from 09:00 to 11:59, a third time slot from 12:00 to 16:59, and a fourth time slot from 17:00 to 23:59 will be described. In addition, in the following description, for convenience of description, the time slot specified as the time slot including the current time in the reference value decision among these four time slots will be referred to as the target time slot.

The information processing device 30 calculates the display performance, for example, track record of the target advertisement in the target time slot within the advertisement display period. In this example, the display performance, for example, track record of the target advertisement is the display proportion of the target advertisement as described above. In this case, the display performance, for example, track record of the target advertisement in the target time slot within the advertisement display period is, for example, a proportion obtained by dividing the cumulative display time of the target advertisement in the target time slot from the start of the advertisement display period to the present by the total cumulative display time of the advertisements C1 to C4 in the target time slot from the start of the advertisement display period to the present. Meanwhile, the display performance, for example, track record of the target advertisement may be the cumulative display time of the target advertisement in the target time slot from the start of the advertisement display period to the present instead of such a display proportion, may be the cumulative number of target advertisement display times in the target time slot from the start of the advertisement display period to the present, or may be any other type of value indicating the display performance, for example, track record of the target advertisement in the target time slot from the start of the advertisement display period to the present.

In addition, the information processing device 30 stores reference values associated with each of the four classifications X1 to X4 for each of the four time slots described above. In the following description, for convenience of description, the reference value associated with the classification X1 will be referred to as a reference value T1. In addition, in the following description, for convenience of description, the reference value associated with the classification X2 will be referred to as a reference value T2. In addition, in the following description, for convenience of description, the reference value associated with the classification X3 will be referred to as a reference value T3. In addition, in the following description, for convenience of description, the reference value associated with the classification X4 will be referred to as a reference value T4. These four reference values T1 to T4 are values that serve as references for the display performance, for example, track records of respective ones of the four advertisements C1 to C4. Specifically, the reference value T1 is a value that serves as a reference for the display performance of the advertisement C1, for example, track record of the advertisement displayed on the display screen. In addition, the reference value T2 is a value that serves as a reference for the display performance of the advertisement C2, for example, track record of the advertisement displayed on the display screen. In addition, the reference value T3 is a value that serves as a reference for the display performance of the advertisement C3, for example, track record of the advertisement displayed on the display screen. In addition, the reference value T4 is a value that serves as a reference for the display performance of the advertisement C4.

These four reference values are determined so that the display performance of each of the four advertisements C1 to C4 is within the reference value, so that an increase in display performance will not be biased toward any of these four advertisements. Meanwhile, these four reference values may be determined by the information processing device 30, may be determined by an information processing device other than the information processing device 30, may be determined by a user of the information processing device 30, or may be determined by another method. A specific example of a method of determining these four reference values will be described later.

In the reference value decision described above, the information processing device 30 calculates the display performance of the target advertisement, and then selects, as the target reference value, a reference value associated with the target classification obtained as a result of the classification determination from among the four reference values T1 to T4 in the specified target time slot. In the reference value decision, the information processing device 30 then determines whether the calculated display performance of the target advertisement exceeds the selected target reference value. In a case that it is determined that the calculated display performance of the target advertisement exceeds the selected target reference value, the information processing device 30 performs the classification determination and the reference value decision on persons to be ordered in the following order among the N persons who are ordered on the basis of the permutation rule. This makes it possible for the information processing device 30 to prevent a target advertisement of which the display performance exceeds the target reference value from being displayed on the display device 10 in the target time slot within the advertisement display period. As a result, the information processing device 30 can prevent an increase in display performance from being biased toward any of the advertisements C1 to C4 in the target time slot within the advertisement display period. On the other hand, in a case that it is determined that the calculated display performance of the target advertisement does not exceed the selected target reference value, the information processing device 30 outputs the target advertisement to the display device 10 without performing the classification determination on persons to be ordered in the following order among the N persons ordered on the basis of the permutation rule, and causes the display device 10 to display the target advertisement. This makes it possible for the information processing device 30 to cause the display device 10 to display an advertisement appropriate for a person with an attribute falling under the target classification in that case.

In this way, in a case that it is determined that the number of persons included in the acquired captured image is N, the information processing device 30 repeatedly performs the classification determination and the reference value decision in order from the first person to the N-th person until it is determined that the calculated display performance of the target advertisement does not exceed the selected target reference value. In a case that it is determined that the calculated display performance of the target advertisement does not exceed the selected target reference value, the information processing device 30 outputs the target advertisement at that point in time to the display device 10 and causes the display device 10 to display the target advertisement. As a result, the information processing device 30 can prevent an increase in display performance from being biased toward any of the advertisements C1 to C4, and can cause the display device 10 to display an advertisement according to the attribute of a viewer of an advertisement displayed on the display device 10.

On the other hand, even in a case that it is determined that the number of persons included in the acquired captured image is zero (that is, in a case that it is determined that the number of persons located within the image capturing region RA is zero), the information processing device 30 specifies the time slot including the current time as the target time slot. The information processing device 30 then calculates the display performance of the target advertisement in the target time slot within the advertisement display period. Thereafter, the information processing device 30 selects, as the target classification, a classification associated with an advertisement out of the advertisements C1 to C4 of which the display performance in the target time slot from the start of the advertisement display period to the present has the greatest degree of falling below the reference value (that is, difference between the display performance and the reference value). Specifically, in that case, the information processing device 30 selects, as the target classification, a classification associated with an advertisement corresponding to the largest value among the degree to which the display performance of the advertisement C1, for example, track record of the advertisement displayed on the display screen, in the target time slot from the start of the advertisement display period to the present falls below the reference value T1, the degree to which the display performance of the advertisement C2, for example, track record of the advertisement displayed on the display screen, in the target time slot from the start of the advertisement display period to the present falls below the reference value T2, the degree to which the display performance of the advertisement C3, for example, track record of the advertisement displayed on the display screen, in the target time slot from the start of the advertisement display period to the present falls below the reference value T3, and the degree to which the display performance of the advertisement C4, for example, track record of the advertisement displayed on the display screen, in the target time slot from the start of the advertisement display period to the present falls below the reference value T4. The information processing device 30 then outputs an advertisement associated with the selected target classification as the target advertisement to the display device 10, and causes the display device 10 to display the target advertisement. Meanwhile, in that case, the information processing device 30 may be configured to select advertisements other than the four advertisements C1 to C4 as target advertisements, and to cause the display device 10 to display the selected target advertisements.

In addition, the information processing device 30 may be configured to store some or all of the advertisements C1 to C4, or may be configured to acquire some or all of the advertisements C1 to C4 from another device (such as, for example, a server).

### Hardware Configuration of Information Processing Device

Hereinafter, the hardware configuration of the information processing device 30 will be described with reference to FIG. 2. FIG. 2 is a diagram illustrating an example of the hardware configuration of the information processing device 30.

The information processing device 30 includes, for example, a processor 31, a storage unit 32, an input acceptance unit 33, a communication unit 34, and a display unit 35. These components are communicably connected to each other through a bus. In addition, the information processing device 30 communicates with the display device 10, the image capturing unit 20, and the like through the communication unit 34.

The processor 31 is, for example, a central processing unit (CPU). Meanwhile, the processor 31 may be another processor such as a field programmable gate array (FPGA) instead of the CPU. The processor 31 executes various programs stored in the storage unit 32.

The storage unit 32 includes, for example, a hard disk drive (HDD), a solid state drive (SSD), an electrically erasable programmable read only memory (EEPROM), a read only memory (ROM), a random access memory (RAM), and the like. Meanwhile, instead of being built into the information processing device 30, the storage unit 32 may be an external storage device connected through a digital input and output port such as a universal serial bus (USB). The storage unit 32 stores various types of information, various types of programs, various types of images, and the like which are processed by the information processing device 30.

The input acceptance unit 33 is an input device such as, for example, a keyboard, a mouse, or a touch pad. Meanwhile, the input acceptance unit 33 may be a touch panel configured integrally with the display unit 35.

The communication unit 34 is configured to include, for example, a digital input and output port such as a USB, an Ethernet (registered trademark) port, an antenna for communication, and the like.

The display unit 35 is a display device including a display panel such as, for example, a liquid crystal display panel or an organic EL display panel.

### Functional Configuration of Information Processing Device

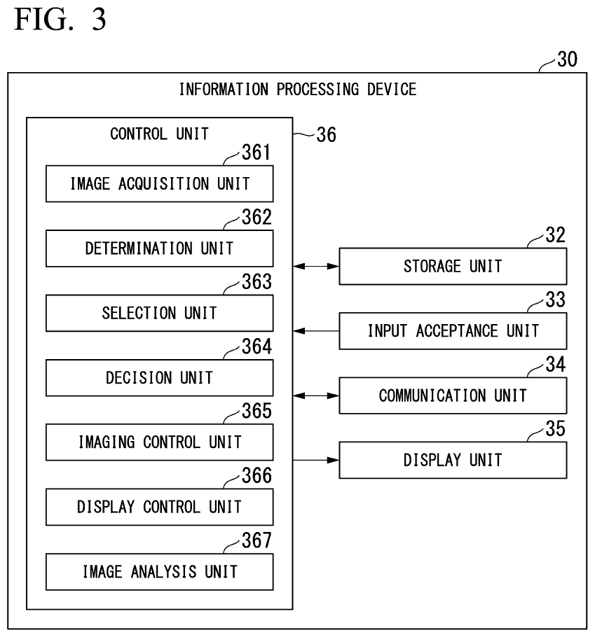

Hereinafter, the functional configuration of the information processing device 30 will be described with reference to FIG. 3. FIG. 3 is a diagram illustrating an example of the functional configuration of the information processing device 30.

The information processing device 30 includes the storage unit 32, the input acceptance unit 33, the communication unit 34, the display unit 35, and a control unit 36.

The control unit 36 controls the entirety of the information processing device 30. The control unit 36 includes an image acquisition unit 361, a determination unit 362, a selection unit 363, a decision unit 364, an imaging the control unit 365, and a display the control unit 366. These functional units included in the control unit 36 are realized, for example, by the processor 31 executing various programs stored in the storage unit 32. In addition, some or all of the functional units may be hardware functional units such as large scale integration (LSI) and an application specific integrated circuit (ASIC).

The image acquisition unit 361 sequentially acquires frames of a moving image captured by the image capturing unit 20 as captured images.

The determination unit 362 performs various determinations which are performed by the information processing device 30. For example, the determination unit 362 performs the above-described classification determination and the like.

The selection unit 363 selects, for example, a target classification, a target reference value, or the like on the basis of the result of determination performed by the determination unit 362.

The decision unit 364 decides each of the reference values T1 to T4. Meanwhile, the information processing device 30 may be configured not to include the decision unit 364. In this case, the information processing device 30 causes the storage unit 32 to store each of the reference values T1 to T4 in accordance with the accepted operation.

The imaging the control unit 365 controls the image capturing unit 20.

The display the control unit 366 generates various images in accordance with the accepted operation. The display the control unit 366 causes the display unit 15 to display the generated image. In addition, the display the control unit 366 causes the display device 10 to display the target advertisement by outputting the above-described target advertisement to the display device 10.

An image analysis unit 367 performs various types of image analysis performed by the information processing device 30.

### Processing in Which Information Processing Device Determines Reference Value

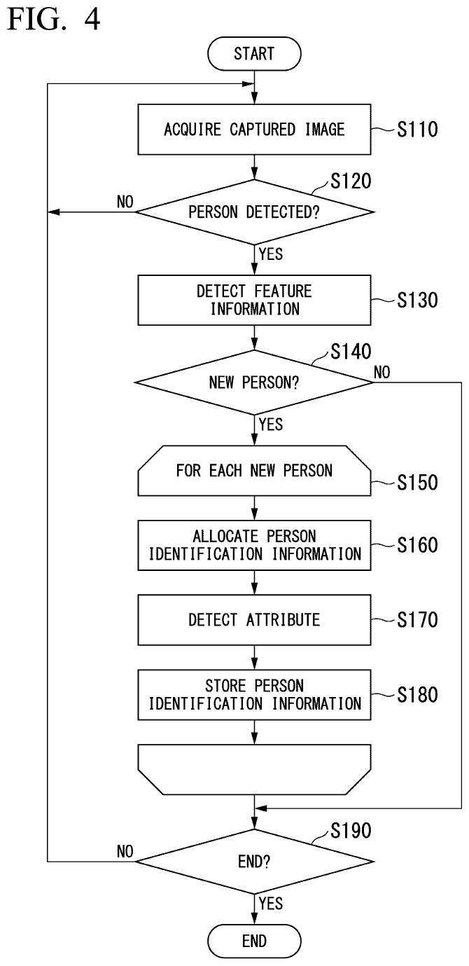

Hereinafter, processing in which the information processing device 30 determines a reference value will be described. The information processing device 30 determines the four reference values T1 to T4 using the aggregation result of the attributes of each of the plurality of persons whose images are captured by the image capturing unit 20 in each time slot with a target period determined in advance in the past (that is, each of the first to fourth time slots described above). Consequently, first, reference will be made to FIG. 4 to describe processing in which the information processing device 30 acquires the aggregation result of the attributes of each of the plurality of persons whose images are captured by the image capturing unit 20 in each time slot within the target period. FIG. 4 is a diagram illustrating an example of a flow of processing in which the information processing device 30 acquires the aggregation result of the attributes of each of the plurality of persons whose images are captured by the image capturing unit 20 in the first time slot within the target period. Meanwhile, the processing in which the information processing device 30 acquires the aggregation result of the attributes of each of the plurality of persons whose images are captured by the image capturing unit 20 in each of the second to fourth time slots within the target period is the same as the processing of the flowchart shown in FIG. 4, and thus the description thereof will be omitted. In addition, the period used as the target period may be a past advertisement display period, may be a period provided in order to obtain the aggregation result, or may be another period. As an example, a case where the target period is a period provided in order to obtain the aggregation result will be described below. In addition, as an example, a case where a first aggregation start operation for starting the processing of acquiring the aggregation result for the attributes of each of the plurality of persons whose images are captured by the image capturing unit 20 in the first time slot within the target period is accepted at a timing before the process of step S110 shown in FIG. 4 is performed will be described below. In addition, as an example, a case where image capturing performed by the image capturing unit 20 has started at the timing will be described below. The information processing device 30 repeatedly performs the processing of the flowchart shown in FIG. 4 every time the start time of the first time slot within the target period arrives. This makes it possible for the information processing device 30 to acquire the aggregation result of the attributes of each of the plurality of persons whose images are captured by the image capturing unit 20 in the first time slot within the target period.

In a case that the start time of the first time slot within the target period has arrived, the image acquisition unit 361 acquires an image captured by the image capturing unit 20 from the image capturing unit 20 (step S110).

Next, the image analysis unit 367 determines whether one or more persons are included in the captured image on the basis of the captured image acquired in step S110 (step S120). In FIG. 4, the process of step S120 is indicated by “person detection?” The method by which the image analysis unit 367 performs the process of step S120 may be a known method, or may be a method to be developed in the future.

In a case that the image analysis unit 367 determines that no person is included in the captured image acquired in step S110 (step S120-NO), the image acquisition unit 361 transitions to step S110 and acquires the image captured by the image capturing unit 20 again from the image capturing unit 20.

On the other hand, in a case that it is determined that one or more persons are included in the captured image acquired in step S110 (step S120-YES), the image analysis unit 367 detects feature information indicating the feature of each of the one or more persons captured in the captured image (step S130). In the following description, for convenience of description, each of the one or more persons captured in the captured image will be referred to as an imaged person. The feature information indicating the feature of each of the one or more imaged persons may be a feature amount indicating the feature of each of the one or more imaged persons, or may be any other type of information indicating the feature of each of the one or more imaged persons.

Next, the determination unit 362 determines whether one or more new persons who have not been detected today by the information processing device 30 are included in the one or more imaged persons on the basis of one or more pieces of feature information detected in step S130 (step S140). Here, in the processes of steps S150 to S180 which will be described later, the image analysis unit 367 causes the storage unit 32 to store person identification information for identifying one or more new persons who have not been detected today by the information processing device 30. The person identification information for identifying a certain person includes feature information indicating the feature of the person and date and time information indicating the date and time when the person identification information has been generated. Therefore, the determination unit 362 can determine whether one or more new persons who have not been detected today by the information processing device 30 are included in the one or more imaged persons on the basis of the one or more pieces of feature information detected in step S130, and the feature information and date and time information included in each of all the pieces of person identification information stored in the storage unit 32. In addition, the determination unit 362 can independently perform such a determination for each day when the flowchart shown in FIG. 4 is executed on the basis of the date and time information included in the person identification information.

In a case that it is determined that one or more new persons who have not been detected today by the information processing device 30 are not included in the one or more imaged persons (step S140-NO), the determination unit 362 determines whether to end the processing of the flowchart shown in FIG. 4 (step S190). For example, in a case that the current time has passed the end time of the first time slot, the determination unit 362 determines that the processing of the flowchart shown in FIG. 4 ends. On the other hand, for example, in a case that the current time has not passed the end time of the first time slot, the determination unit 362 determines that the processing of the flowchart shown in FIG. 4 does not end. Meanwhile, the determination unit 362 may perform the determination in step S190 using another method.

In a case that the determination unit 362 determines that the processing of the flowchart shown in FIG. 4 does not end (step S190-NO), the image acquisition unit 361 proceeds to step S110 and acquires the image captured by the image capturing unit 20 again from the image capturing unit 20.

On the other hand, in a case that it is determined that the processing of the flowchart shown in FIG. 4 ends (step S190-YES), the determination unit 362 ends the processing of the flowchart shown in FIG. 4.

On the other hand, in step S140, in a case that the determination unit 362 determines that one or more new persons who have not been detected today by the information processing device 30 are included in the one or more imaged persons (step S140-YES), the image analysis unit 367 selects the one or more new persons one by one as a first target person, and repeatedly performs the processes of steps S160 to S180 for each selected first target person (step S150). In FIG. 4, the process of step S150 is indicated by “for each new person.”

After the first target person is selected in step S150, the image analysis unit 367 generates person identification information including information for identifying the selected first target person (such as, for example, an identifier (ID) for identifying the first target person), feature information indicating the feature of the first target person detected in step S130, and date and time information indicating the current date and time. Thereby, the image analysis unit 367 allocates the generated person identification information to the first target person (step S160).

Next, the image analysis unit 367 detects the attribute of the first target person on the basis of the captured image acquired in step S110 (step S170). Meanwhile, the method in which the image analysis unit 367 detects the attribute of the first target person from the captured image in step S170 may be a known method, or may be a method to be developed in the future. In addition, the processes of steps S160 and S170 may be performed in parallel, or may be performed in the reverse order.

Next, the determination unit 362 determines which of the classifications X1 to X4 the attribute detected in step S170 falls under. The image analysis unit 367 associates classification information indicating the classification obtained as a result of determination by the determination unit 362 with the person identification information allocated to the first target person in step S160, and causes the storage unit 32 to store it (step S180).

After the process of step S180 is performed, the image analysis unit 367 proceeds to step S150 and selects the next first target person. Meanwhile, in a case that the decision unit 364 decides in step S150 that there is no person who has not been selected as the first target person, the determination unit 362 ends the processes of steps S150 to S180, proceeds to step S190, and determines whether to end the processing of the flowchart shown in FIG. 4.

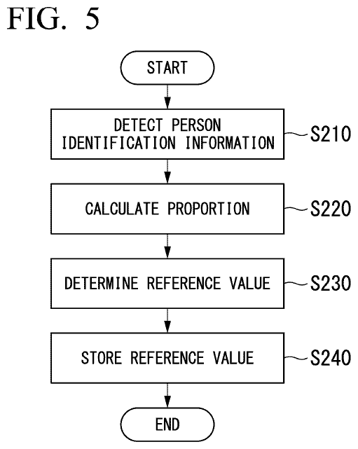

By repeatedly performing above-described processing for each first time slot within the target period, the information processing device 30 can cause the storage unit 32 to store the person identification information with which the classification information is associated, as a result of aggregation of the attributes of each of the plurality of persons whose images are captured by the image capturing unit 20 in the first time slot within the target period. The information processing device 30 then determines each of the reference values T1 to T4 in the first time slot by performing the processing of the flowchart shown in FIG. 5 on the basis of the aggregation result obtained in this way (that is, person identification information with which the classification information is associated). FIG. 5 is a diagram illustrating an example of a flow of processing in which the information processing device 30 determines a reference value in the first time slot on the basis of the person identification information. Meanwhile, the processing in which the information processing device 30 determines a reference value in each of the second to fourth time slots on the basis of the person identification information is the same as the processing of the flowchart shown in FIG. 5, and thus the description thereof will be omitted. In addition, as an example, a case where the information processing device 30 accepts a reference value decision start operation for causing the information processing device 30 to start a process of determining the reference value in the first time slot at a timing before the process of step S210 shown in FIG. 5 is performed will be described below. In addition, as an example, a case where the processing of the flowchart shown in FIG. 4 is executed at the timing, and the person identification information for identifying each of all the persons detected from the captured image in the first time slot within the target period is stored in the storage unit 32 will be described below.

After the reference value decision start operation is accepted, the decision unit 364 reads out, from the storage unit 32, all the pieces of person identification information stored in the first time slot within the target period among all the pieces of person identification information stored in the storage unit 32 (step S210).

Next, the decision unit 364 calculates the proportion of persons with attributes falling under each of the classifications X1 to X4 on the basis of all the pieces of person identification information read out in step S210 (step S220). In FIG. 5, the process of step S220 is indicated by “calculate proportion.” For example, in step S220, the decision unit 364 calculates the number XN1 of pieces of person identification information including classification information indicating the classification X1, the number XN2 of pieces of person identification information including classification information indicating the classification X2, the number XN3 of pieces of person identification information including classification information indicating the classification X3, and the number XN4 of pieces of person identification information including classification information indicating the classification X4, on the basis of all the pieces of person identification information read out in step S210. The decision unit 364 then calculates the value obtained by dividing the number XN1 by the sum of the numbers XN1 to XN4 as the proportion of persons with attributes falling under the classification X1. In addition, the decision unit 364 also calculates the proportion of persons with attributes falling under each of the classifications X2 to X4 using the same method as this. Meanwhile, the decision unit 364 may be configured to calculate the proportion of persons with attributes falling under each of the classifications X1 to X4 using another method in step S220. In the following description, for convenience of description, the proportion of persons with attributes falling under the classification X1 will be referred to as the proportion XR1. In addition, in the following description, for convenience of description, the proportion of persons with attributes falling under the classification X2 will be referred to as a proportion XR2. In addition, in the following description, for convenience of description, the proportion of persons with attributes falling under the classification X3 will be referred to as a proportion XR3. In addition, in the following description, for convenience of description, the proportion of persons with attributes falling under the classification X4 will be referred to as a proportion XR4.

Next, the decision unit 364 decides each of the reference values T1 to T4 on the basis of the proportion calculated in step S220 (step S230). For example, in step S230, the decision unit 364 specifies the proportion exceeding the upper limit of the reference value among the proportions XR1 to XR4 as an upper limit exceeding proportion. The upper limit of the reference value is a value determined in advance as a common upper limit for each of the reference values T1 to T4, and is for example, 50%. Meanwhile, the upper limit of the reference value may be any other proportion insofar as it is a proportion of 50% or more. In a case that the upper limit of the reference value is determined in this way, the upper limit exceeding proportion is only any one of the proportions XR1 to XR4 even in a case that the upper limit exceeding proportion is included in the proportions XR1 to XR4. In addition, for example, in step S230, the decision unit 364 specifies the proportion of the proportions XR1 to XR4 falling below the lower limit of the reference value as a lower limit exceeding proportion. The lower limit of the reference value is a value determined in advance as a common lower limit for each of the reference values T1 to T4, and is, for example, 10%. Meanwhile, the lower limit of the reference value may be a proportion lower than 10% or a proportion higher than 10% insofar as it is a proportion lower than the upper limit of the reference value.

In a case that the upper limit exceeding proportion and the lower limit exceeding proportion are not included in the proportions XR1 to XR4, the decision unit 364 decides the proportions XR1 to XR4 as the reference values T1 to T4, respectively. That is, in that case, the decision unit 364 decides the proportion XR1 as the reference value T1, determines the proportion XR2 as the reference value T2, determines the proportion XR3 as the reference value T3, and determines the proportion XR4 as the reference value T4.

On the other hand, in a case that the upper limit exceeding proportion and the lower limit exceeding proportion are included in the proportions XR1 to XR4, the decision unit 364 decides the reference value for the classification corresponding to the upper limit exceeding proportion to be the same value as the upper limit of the reference value. The decision unit 364 then determines a value obtained by adding (the upper limit exceeding proportion-the upper limit of the reference value) to the lower limit exceeding proportion as the reference value for the classification corresponding to the lower limit exceeding proportion. However, the addition and subtraction of these proportions is the addition and subtraction of values excluding “%” (that is, for example, “5%+(60%−50%)” is calculated as 15%). In addition, the decision unit 364 decides each of the remaining two proportions as a reference value for each of the classifications corresponding to the remaining two proportions. For example, a case where the proportion XR1 is 60%, the proportion XR2 is 5%, the proportion XR3 is 15%, and the proportion XR4 is 20% can be considered. In this case, the upper limit exceeding proportion is the proportion XR1. In addition, in this case, the lower limit exceeding proportion is the proportion XR2. Therefore, in this case, the decision unit 364 decides the reference value T1 for the classification X1 corresponding to the proportion XR1 which is the upper limit exceeding proportion to be the same value as the upper limit of the reference value (50% in this example). In addition, in this case, the decision unit 364 decides a value (15% in this example) obtained by adding (the upper limit exceeding proportion-the upper limit of the reference value) to the proportion XR2 which is the lower limit exceeding proportion as the reference value T2 for the classification X2 corresponding to the proportion XR2. In this case, the decision unit 364 then decides the proportion XR3 as the reference value T3 for the classification X3 corresponding to the proportion XR3, and determines the proportion XR4 as the reference value T4 for the classification X4 corresponding to the proportion XR4.

In addition, in a case that the upper limit exceeding proportion is included in the proportions XR1 to XR4, the decision unit 364 decides the reference value for the classification corresponding to the upper limit exceeding proportion to be the same value as the upper limit of the reference value. The decision unit 364 then decides the value obtained by adding (the upper limit exceeding proportion-the upper limit of the reference value) to the lowest proportion among the remaining three proportions as the reference value for the classification corresponding to the lowest proportion. In addition, the decision unit 364 decides each of the remaining two proportions as a reference value for each of the classifications corresponding to the remaining two proportions. For example, a case where the proportion XR1 is 60%, the proportion XR2 is 10%, the proportion XR3 is 15%, and the proportion XR4 is 15% can be considered. In this case, the upper limit exceeding proportion is the proportion XR1. In addition, in this case, the lowest proportion is the proportion XR2. Therefore, in this case, the decision unit 364 decides the reference value T1 for the classification X1 corresponding to the proportion XR1 which is the upper limit exceeding proportion to be the same value as the upper limit of the reference value (50% in this example). In addition, in this case, the decision unit 364 decides the value (20% in this example) obtained by adding (the upper limit exceeding proportion-the upper limit of the reference value) to the proportion XR2 which is the lowest proportion as the reference value T2 for the classification X2 corresponding to the proportion XR2. In this case, the decision unit 364 then decides the proportion XR3 as the reference value T3 for the classification X3 corresponding to the proportion XR3, and determines the proportion XR4 as the reference value T4 for the classification X4 corresponding to the proportion XR4. Meanwhile, in a case that two or more lowest proportions are included in the proportions XR1 and XR2, the decision unit 364 decides, for example, a value obtained by equally distributing (the upper limit exceeding proportion-the upper limit of the reference value) for the two or more proportions as the reference value for the classification corresponding to each of the two or more proportions.

In addition, in a case that the lower limit exceeding proportion is included in the proportions XR1 to XR4, the decision unit 364 decides the reference value for the classification corresponding to the lower limit exceeding proportion to be the same value as the lower limit of the reference value. The decision unit 364 then decides the value obtained by subtracting (the lower limit of the reference value-the lower limit exceeding proportion) from the highest proportion among the remaining three proportions as the reference value for the classification corresponding to the highest proportion. In addition, the decision unit 364 decides each of the remaining two proportions as a reference value for each of the classifications corresponding to the remaining two proportions. For example, a case where the proportion XR1 is 50%, the proportion XR2 is 5%, the proportion XR3 is 15%, and the proportion XR4 is 30% can be considered. In this case, the lower limit exceeding proportion is the proportion XR2. In addition, in this case, the highest proportion is the proportion XR1. Therefore, in this case, the decision unit 364 decides the reference value T2 for the classification X2 corresponding to the proportion XR2 which is the lower limit exceeding proportion to be the same value as the lower limit of the reference value (10% in this example). In addition, in this case, the decision unit 364 decides the value (45% in this example) obtained by subtracting (the lower limit of the reference value-the lower limit exceeding proportion) from the proportion XR1 which is the highest proportion as the reference value T1 for the classification X1 corresponding to the proportion XR1. In this case, the decision unit 364 then decides the proportion XR3 as the reference value T3 for the classification X3 corresponding to the proportion XR3, and determines the proportion XR4 as the reference value T4 for the classification X4 corresponding to the proportion XR4. Meanwhile, in a case that two or more highest proportions are included in the proportions XR1 and XR2, the decision unit 364 decides, for example, a value obtained by equally distributing (the lower limit of the reference value-the lower limit exceeding proportion) for the two or more proportions as the reference value for the classification corresponding to each of the two or more proportions.

Meanwhile, either or both of the upper limit of the reference value and the lower limit of the reference value may be configured not to be determined in the information processing device 30.

After the process of step S230 is performed, the decision unit 364 causes the storage unit 32 to store each of the reference values T1 to T4 determined in step S230 as the reference values T1 to T4 in the first time slot (step S240), and ends the processing of the flowchart shown in FIG. 5.

As described above, the information processing device 30 determines the reference values T1 to T4 on the basis of the number of times the attributes of persons included in the captured image in the first time slot within the target period are determined to fall under each of the classifications X1 to X4. This makes it possible for the information processing device 30 to determine the reference values T1 to T4 for each time slot in accordance with the proportion of the attributes of each of the plurality of persons who view the display device 10 in each time slot. As a result, the information processing device 30 can prevent an increase in display performance from being biased toward a specific advertisement, and can more reliably display an advertisement according to the attribute of a viewer on the display device 10.

### Processing in Which Information Processing Device Causes Display Device to Display Advertisement

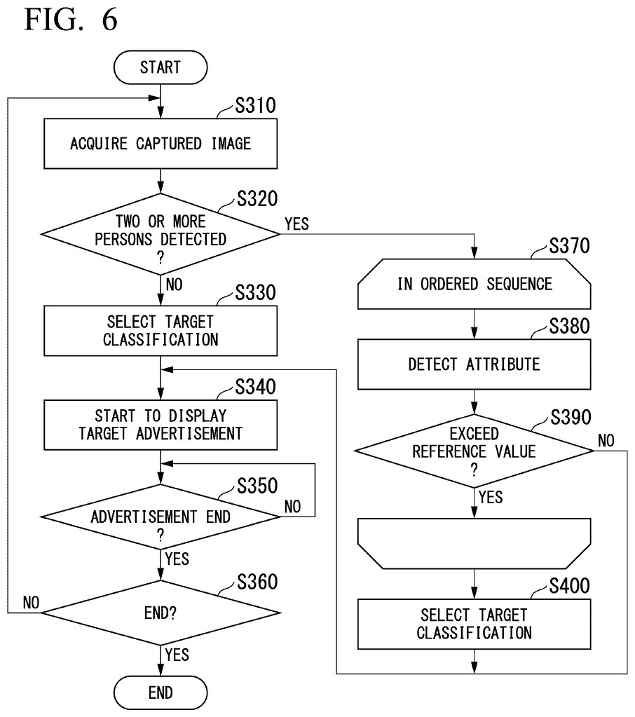

Hereinafter, reference will be made to FIG. 6 to describe processing in which the information processing device 30 causes the display device 10 to display an advertisement in the first time slot within the advertisement display period. FIG. 6 is a diagram illustrating an example of a flow of processing in which the information processing device 30 causes the display device 10 to display an advertisement in the first time slot within the advertisement display period. The information processing device 30 repeatedly performs processing of the flowchart shown in FIG. 6 every time the start time of the first time slot within the advertisement display period arrives. This makes it possible for the information processing device 30 to display an advertisement according to the attribute of the viewer on the display device 10 while preventing an increase in display performance from being biased toward a specific advertisement in the first time slot within the advertisement display period.

In a case that the start time of the first time slot within the advertisement display period has arrived, the image acquisition unit 361 acquires the image captured by the image capturing unit 20 from the image capturing unit 20 (step S310).

Next, the image analysis unit 367 determines whether two or more persons are included in the captured image on the basis of the captured image acquired in step S310 (step S320). In FIG. 6, the process of step S320 is indicated by “two or more persons detected?” The method in which the image analysis unit 367 performs the process of step S320 may be a known method, or may be a method to be developed in the future.

In a case that the image analysis unit 367 determines that two or more persons are not included in the captured image on the basis of the captured image acquired in step S310 (step S320-NO), the selection unit 363 selects the target classification (step S330). Specifically, for example, in a case that no person is included in the captured image, the selection unit 363 specifies the time slot (in this example, the first time slot) including the current time as the target time slot. The selection unit 363 then calculates the display performance of each advertisement (that is, each of the advertisements C1 to C4) in the target time slot within the advertisement display period. Thereafter, the selection unit 363 selects, as the target classification, a classification associated with an advertisement out of the advertisements C1 to C4 of which the display performance in the target time slot from the start of the advertisement display period to the present has the greatest degree of falling below the reference value (that is, difference between the display performance and the reference value). Meanwhile, a specific example of a method of selecting the target classification in that case has already been described, and thus the description thereof will be omitted. On the other hand, for example, in a case that one person is included in the captured image, the determination unit 362 determines which of a plurality of classifications determined in advance the attribute of the person included in the captured image falls under, for the attribute of a viewer of the advertisement displayed on the display screen of the display device 10. Even if the display performance of an advertisement associated with a classification obtained as a result of this determination by the determination unit 362 exceeds a reference value associated with the classification, the selection unit 363 selects the classification as the target classification.

The display control unit 366 outputs the target advertisement associated with the target classification selected in step S330 to the display device 10, and starts to display the target advertisement on the display device 10 (step S340).

Next, the determination unit 362 waits until the display of the target advertisement (that is, the display of the moving image of the target advertisement) started in step S340 is completed (step S350).

In a case that it is determined that the display of the target advertisement started in step S340 has ended (step S350-YES), the determination unit 362 determines whether to end the processing of the flowchart shown in FIG. 6 (step S360). For example, in a case that the current time has passed the end time of the first time slot, the determination unit 362 determines that the processing of the flowchart shown in FIG. 6 ends. On the other hand, for example, in a case that the current time has not passed the end time of the first time slot, the determination unit 362 determines that the processing of the flowchart shown in FIG. 6 does not end. Meanwhile, the determination unit 362 may perform the determination in step S360 using another method.

In a case that the determination unit 362 determines that the processing of the flowchart shown in FIG. 6 does not end (step S360-NO), the image acquisition unit 361 proceeds to step S310 and acquires the image captured by the image capturing unit 20 again from the image capturing unit 20.

On the other hand, in a case that it is determined that the processing of the flowchart shown in FIG. 6 ends (step S360-YES), the determination unit 362 ends the processing of the flowchart shown in FIG. 6.

On the other hand, in a case that the image analysis unit 367 determines that two or more persons are included in the captured image on the basis of the captured image acquired in step S310 (step S320-YES), the selection unit 363 orders two or more persons included in the captured image on the basis of the permutation rule. The selection unit 363 then selects the two or more ordered persons as the target person one by one starting with the first one, and repeatedly performs the processes of steps S380 to S390 for selected target person (step S370). Here, the ordering based on the permutation rule in step S370 will be described.

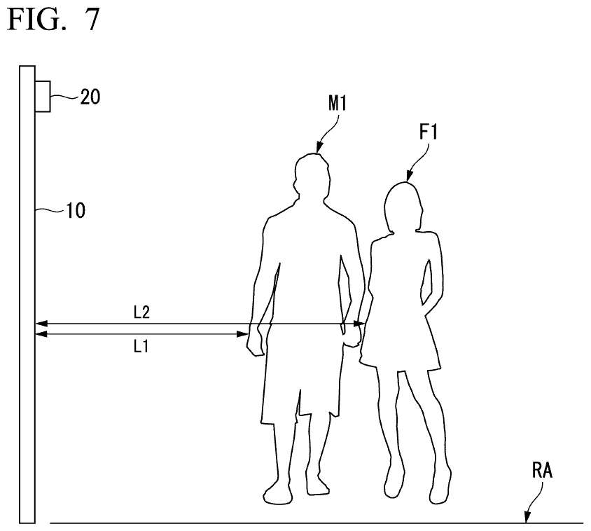

FIG. 7 is a diagram illustrating an example of a state in which two persons are located within the image capturing region RA. In the example shown in FIG. 7, the distance between a person M1 and the display device 10 is L1. On the other hand, in this example, the distance between a person F1 and the display device 10 is L2. L1 is a shorter distance than L2. In this case, the selection unit 363 orders the person M1 and the person F1 in the order of the person M1 and the person F1. That is, in that case, the selection unit 363 selects the person M1 as a first person and selects the person F1 as a second person. In this way, the selection unit 363 selects, as the first person, the person M1 whose image is captured by the image capturing unit 20 at a position closer to the display device 10 than the person F1.

After the target person is selected in step S370, the image analysis unit 367 is detected the attribute of the selected target person on the basis of the captured image acquired in step S310 (step S380).

Next, the determination unit 362 determines which of the classifications X1 to X4 the attribute detected in step S380 falls under through the classification determination. The selection unit 363 then determines whether the target advertisement associated with the target classification obtained as a result of this determination by the determination unit 362 exceeds the reference value associated with the target classification (step S390).

In a case that the determination unit 362 determines that the target advertisement associated with the target classification exceeds the reference value associated with the target classification (step S390-YES), the selection unit 363 proceeds to step S370 and selects the next target person. Meanwhile, in a case that it is determined in step S370 that there is no person who has not been selected as the target person, the selection unit 363 ends the processes of steps S370 to S390. In the repeated processes of steps S370 to S390 that have been completed, the selection unit 363 then selects the classification associated with the target advertisement among the classifications X1 to X4 as the target classification by reselecting, as the target advertisement, the advertisement with the smallest difference between the display performance, for example, track record and the reference value (that is, the degree to which the display performance, for example, track record exceeds the reference value) among the advertisements C1 to C4 (step S400). Thereafter, the display control unit 366 proceeds to step S340, outputs the target advertisement associated with the target classification selected in step S400 to the display device 10, and causes the display device 10 to display the target advertisement.

On the other hand, in a case that the selection unit 363 determines that the target advertisement associated with the target classification exceeds the reference value associated with the target classification (step S390-NO), the display control unit 366 ends the processes of steps S370 to S390, proceeds to step S340, outputs the target advertisement associated with the currently selected target classification to the display device 10, and causes the display device 10 to display the target advertisement.

As described above, the information processing device 30 acquires a captured image obtained by capturing an image of the image capturing region RA including a position at which the display screen of the display device 10 is visible, stores reference values (in this example, reference values T1 to T4) associated with each of a plurality of classifications (in this example, classifications X1 to X4) determined in advance for an attribute of a viewer of an advertisements displayed on the display screen, determines which of the plurality of classifications the attribute of the person included in the captured image falls under, selects any of the plurality of classifications on the basis of at least the display performance of the advertisement, for example, track record of the advertisement displayed on the display screen, and the determination result, and causes the display screen to display the advertisement associated with the selected classification. Here, in a case that at least a first person and a second person are included in the captured image, the information processing device 30 selects a second classification when performing a first determination that involves determining that the display performance, for example, track record of a first advertisement (such as, for example, the advertisement C1) which is the advertisement associated with a first classification (such as, for example, the classification X1) determined with respect to the attribute of the first person exceeds a first reference value (for example, the reference value T1) which is the reference value associated with the first classification, and a second determination that involves determining that the display performance, for example, track record of a second advertisement (such as, for example, the advertisement C2) which is the advertisement associated with the second classification (such as, for example, the classification X2) determined with respect to the attribute of the second person does not exceed a second reference value (such as, for example, the reference value T2) which is the reference value associated with the second classification. This makes it possible for the information processing device 30 to prevent an increase in display performance, for example, track record from being biased toward a specific advertisement, and to display an advertisement according to the attribute of the viewer on the display device 10.

In addition, in a case that a third person is included in the captured image together with the first person and the second person, the information processing device 30 selects a third classification when performing the first determination described above, a third determination that involves determining that the display performance, for example, track record of the second advertisement exceeds the second reference value, and a fourth determination that involves determining that the display performance, for example, track record of a third advertisement (such as, for example, the advertisement C3) which is the advertisement associated with the third classification (such as, for example, the classification X3) determined with respect to the attribute of the third person does not exceed a third reference value (such as, for example, the reference value T3) which is the reference value associated with the third classification. This makes it possible for the information processing device 30 to more reliably prevent an increase in display performance from being biased toward a specific advertisement, and to display an advertisement according to the attribute of the viewer on the display device 10.

Meanwhile, in a case that it is determined in step S320 that two or more persons are included in the captured image on the basis of the captured image acquired in step S310, the image analysis unit 367 may be configured to detect the attribute of each of the two or more persons included in the captured image before proceeding to step S370. In this case, the process of step S380 is omitted. In addition, in this case, the determination unit 362 determines which of the classifications X1 to X4 the attribute detected for each of the two or more persons falls under, before proceeding to step S370. In a case that the determination unit 362 determines that the attributes of the two or more persons fall under a certain classification with the same attributes, the selection unit 363 omits the repeated processes of steps S370 to S390, proceeds to step S400, and selects the one classification as the target classification even if the display performance of the advertisement, for example, track record of the advertisement displayed on the display screen, associated with the one classification exceeds the reference value associated with the one classification.

In addition, the matters described above may be combined in any way.

### Supplement

[1] An information processing device including: an acquisition unit that acquires a captured image obtained by capturing an image of an image capturing region including a position at which a display screen of a display device is visible; a storage unit that stores a reference value associated with each of a plurality of classifications determined in advance for an attribute of a viewer of an advertisement displayed on the display screen; a determination unit that determines which of the plurality of classifications an attribute of a person included in the captured image falls under; a selection unit that selects any of the plurality of classifications on the basis of at least display performance of the advertisement, for example, track record of the advertisement displayed on the display screen and a determination result of the determination unit; and a display control unit that causes the display screen to display the advertisement associated with the classification selected by the selection unit, wherein, in a case that at least a first person and a second person are included in the captured image, the selection unit selects a second classification when performing a first determination that involves determining that display performance, for example, track record of a first advertisement which is the advertisement associated with a first classification determined by the determination unit with respect to an attribute of the first person exceeds a first reference value which is the reference value associated with the first classification, and a second determination that involves determining that display performance, for example, track record of a second advertisement which is the advertisement associated with the second classification determined by the determination unit with respect to an attribute of the second person does not exceed a second reference value which is the reference value associated with the second classification.

[2] The information processing device according to [1], wherein the second determination is performed after the first determination, and the second determination being performed after the first determination is determined on the basis of at least one of respective orientations of faces of the first person and the second person included in the captured image and respective distances of the first person and the second person included in the captured image from the display device.

[3] The information processing device according to [1], wherein, in a case that the first person and the second person are included in the captured image and a case where the determination unit determines that both the attribute of the first person and the attribute of the second person fall under one of the first classification and the second classification, the selection unit selects the one even if the display performance of the advertisement, for example, track record of the advertisement displayed on the display screen associated with the one exceeds the reference value associated with the one.

[4] The information processing device according to any one of [1] to [3], wherein the plurality of classifications are classifications based on at least one of age and sex.

[5] The information processing device according to any one of [1] to [4], wherein, in a case that a third person is included in the captured image together with the first person and the second person, the selection unit selects a third classification when performing the first determination, a third determination that involves determining that the display performance of the second advertisement exceeds the second reference value, and a fourth determination that involves determining that display performance, for example, track record of a third advertisement which is the advertisement associated with the third classification determined by the determination unit with respect to an attribute of the third person does not exceed a third reference value which is the reference value associated with the third classification.

[6] The information processing device according to any one of [1] to [5], wherein, in a case that at least the first person and the second person are included in the captured image, the selection unit selects the first classification when performing a fifth determination that involves determining that the display performance, for example, track record of the first advertisement does not exceed the first reference value.

[7] The information processing device according to any one of [1] to [6], wherein the first person is a person whose image is captured at a position closer to the display device than the second person. [8] The information processing device according to any one of [1] to [7], further including a determination unit that determines the first reference value and the second reference value on the basis of the number of times the determination unit has determined that the attribute of the person included in the captured image falls under the first classification within a first period determined in advance in the past and the number of times the determination unit has determined that the attribute of the person included in the captured image falls under the second classification within the first period. [9] The information processing device according to any one of [1] to [8], wherein, in a case that a person is not included in the captured image, the selection unit selects any of the first classification and the second classification on the basis of the display performance, for example, track record of the first advertisement, the display performance, for example, track record of the second advertisement, the first reference value, and the second reference value.

[10] The information processing device according to [9], wherein, in a case that a person is not included in the captured image, the selection unit selects the first classification in a case that a difference between the display performance, for example, track record of the first advertisement and the first reference value is less than a difference between the display performance, for example, track record of the second advertisement and the second reference value, and selects the second classification in a case that the difference between the display performance, for example, track record of the first advertisement and the first reference value is equal to or greater than the difference between the display performance, for example, track record of the second advertisement and the second reference value.

[11] An information processing device including: an acquisition unit that acquires a captured image obtained by capturing an image of an image capturing region including a position at which a display screen of a display device is visible; a storage unit that stores a plurality of reference values associated with a plurality of classifications determined in advance for an attribute of a viewer of an advertisement displayed on the display screen; a determination unit that determines which of the plurality of classifications an attribute of a person included in the captured image falls under; a selection unit that selects any of the plurality of classifications on the basis of at least display performance of the advertisement, for example, track record of the advertisement displayed on the display screen and a determination result of the determination unit; and a display control unit that causes the display screen to display the advertisement associated with the classification selected by the selection unit, wherein, in a case that at least a first person is included in the captured image, the selection unit selects any of the plurality of classifications in accordance with different conditions depending on whether a person other than the first person is included in the captured image when the display performance of the advertisement, for example, track record of the advertisement displayed on the display screen associated with a first classification determined by the determination unit with respect to an attribute of the first person exceeds a first reference value which is the reference value associated with the first classification.

[12] The information processing device according to [11], wherein, in a case that a person other than the first person is not included in the captured image, the selection unit selects the first classification even if the display performance of the advertisement, for example, track record of the advertisement displayed on the display screen associated with the first classification exceeds the first reference value.

[13] The information processing device according to [11], wherein, in a case that a second person is included in the captured image together with the first person and the display performance of the advertisement, for example, track record of the advertisement displayed on the display screen associated with the first classification determined by the determination unit with respect to the attribute of the first person exceeds the first reference value associated with the first classification, the selection unit determines whether display performance, for example, track record of a second advertisement which is the advertisement associated with a second classification determined by the determination unit with respect to an attribute of the second person does not exceed a second reference value which is the reference value associated with the second classification, and selects any of the plurality of classifications in accordance with a result of the determination.

[14] An information processing method including: an acquisition step of acquiring a captured image obtained by capturing an image of an image capturing region including a position at which a display screen of a display device is visible; a determination unit determining which of a plurality of classifications determined in advance an attribute of a person included in the captured image falls under, for an attribute of a viewer of an advertisement displayed on the display screen; a selection step of selecting any of the plurality of classifications on the basis of at least display performance of the advertisement, for example, track record of the advertisement displayed on the display screen and a determination result of the determination unit; and a display control step of causing the display screen to display the advertisement associated with the classification selected in the selection step, wherein, in a case that at least a first person and a second person are included in the captured image, the selection step includes selecting a second classification when performing a first determination that involves determining that display performance, for example, track record of a first advertisement which is the advertisement associated with a first classification determined by the determination unit with respect to an attribute of the first person exceeds a first reference value which is the reference value associated with the first classification among reference values associated with each of the plurality of classifications, and a second determination that involves determining that display performance, for example, track record of a second advertisement which is the advertisement associated with the second classification determined by the determination unit with respect to an attribute of the second person does not exceed a second reference value which is the reference value associated with the second classification.

[15] An information processing system including: an image capturing unit that captures an image of an image capturing region including a position at which a display screen of a display device is visible; and an information processing device, wherein the information processing device includes an acquisition unit that acquires an image captured by the image capturing unit, a storage unit that stores a reference value associated with each of a plurality of classifications determined in advance for an attribute of a viewer of an advertisement displayed on the display screen, a determination unit that determines which of the plurality of classifications an attribute of a person included in the captured image falls under, a selection unit that selects any of the plurality of classifications on the basis of at least display performance of the advertisement, for example, track record of the advertisement displayed on the display screen and a determination result of the determination unit, and a display control unit that causes the display screen to display the advertisement associated with the classification selected by the selection unit, and in a case that at least a first person and a second person are included in the captured image, the selection unit selects a second classification when performing a first determination that involves determining that display performance, for example, track record of a first advertisement which is the advertisement associated with a first classification determined by the determination unit with respect to an attribute of the first person exceeds a first reference value which is the reference value associated with the first classification, and a second determination that involves determining that display performance, for example, track record of a second advertisement which is the advertisement associated with the second classification determined by the determination unit with respect to an attribute of the second person does not exceed a second reference value which is the reference value associated with the second classification.

Hereinbefore, although the embodiment of this invention has been described in detail with reference to the drawings, the specific configuration is not limited to this embodiment, and may be changed, replaced, deleted, and the like without departing from the gist of this invention.

In addition, a program for realizing the functions of arbitrary components in the device described above may be recorded on a computer-readable recording medium, and the program may be read and executed by a computer system. Here, the device is, for example, the information processing device 30 or the like. Meanwhile, the “computer system” referred to herein includes an OS and hardware such as peripheral equipment. In addition, the “computer-readable recording medium” refers to a portable medium such as a flexible disk, a magneto-optical disc, a ROM, or a compact disk (CD)-ROM, or a storage device such as a hard disk which is built into the computer system. Further, the “computer-readable recording medium” is assumed to include recording mediums that holds a program for a certain period of time like a volatile memory inside a computer system serving as a server or a client when a program is transmitted through networks such as the Internet or communication lines such as a telephone line.

In addition, the above program may be transmitted from a computer system that stores this program in a storage device or the like to another computer system through a transmission medium or using transmission waves in a transmission medium. Here, the “transmission medium” that transmits the program refers to a medium that has a function of transmitting information like networks such as the Internet or communication lines such as a telephone line.

In addition, the above-mentioned program may realize a portion of the above-mentioned functions. Further, the above-mentioned program may be a so-called difference file or a difference program capable of realizing the above-mentioned functions by a combination with a program which is already recorded in a computer system.

### Reference Signs List

1 Information processing system
10 Display device
15 Display unit
20 Image capturing unit
30 Information processing device
31 Processor
32 Storage unit
33 Input acceptance unit
34 Communication unit
35 Display unit
36 Control unit
361 Image acquisition unit
362 Determination unit
363 Selection unit
364 Decision unit
365 Imaging control unit
366 Display control unit
367 Image analysis unit
RA Image capturing region

What is claimed is:

1. An information processing device comprising:
an acquisition unit that acquires a captured image obtained by capturing an image of an image capturing region including a position at which a display screen of a display device is visible;
a storage unit that stores a reference value associated with each of a plurality of classifications determined in advance for an attribute of a viewer of an advertisement displayed on the display screen;
a determination unit that determines which of the plurality of classifications an attribute of a person included in the captured image falls under;
a selection unit that selects any of the plurality of classifications on the basis of at least track record of the advertisement displayed on the display screen and a determination result of the determination unit; and
a display control unit that causes the display screen to display the advertisement associated with the classification selected by the selection unit,
wherein, in a case that at least a first person and a second person are included in the captured image, the selection unit selects a second classification when performing:
a first determination that involves determining that track record of a first advertisement which is the advertisement associated with a first classification determined by the determination unit with respect to an attribute of the first person exceeds a first reference value which is the reference value associated with the first classification, and
a second determination that involves determining that track record of a second advertisement which is the advertisement associated with the second classification determined by the determination unit with respect to an attribute of the second person does not exceed a second reference value which is the reference value associated with the second classification.

2. The information processing device according to claim 1, wherein the second determination is performed after the first determination, and
the second determination being performed after the first determination is determined on the basis of at least one of respective orientations of respective faces of the first person and the second person included in the captured image and respective distances of the first person and the second person included in the captured image from the display device.

3. The information processing device according to claim 1, wherein, in a case that the first person and the second person are included in the captured image and a case where the determination unit determines that both the attribute of the first person and the attribute of the second person fall under one of the first classification and the second classification, the selection unit selects the one even if the track record of the advertisement displayed on the display screen associated with the one exceeds the reference value associated with the one.

4. The information processing device according to claim 1, wherein the plurality of classifications are classifications based on at least one of age and sex.

5. The information processing device according to claim 1, wherein, in a case that a third person is included in the captured image together with the first person and the second person, the selection unit selects a third classification when performing:
the first determination,
a third determination that involves determining that the track record of the second advertisement exceeds the second reference value, and
a fourth determination that involves determining that track record of a third advertisement which is the advertisement associated with the third classification determined by the determination unit with respect to an attribute of the third person does not exceed a third reference value which is the reference value associated with the third classification.

6. The information processing device according to claim 1, wherein, in a case that at least the first person and the second person are included in the captured image, the selection unit selects the first classification when performing a fifth determination that involves determining that the track record of the first advertisement does not exceed the first reference value.

7. The information processing device according to claim 1, wherein the first person is a person whose image is captured at a position closer to the display device than the second person.

8. The information processing device according to claim 1, further comprising:
a decision unit that decides the first reference value and the second reference value on the basis of the number of times the determination unit has determined that the attribute of the person included in the captured image falls under the first classification within a first period determined in advance in the past and the number of times the determination unit has determined that the attribute of the person included in the captured image falls under the second classification within the first period.

9. The information processing device according to claim 1, wherein, in a case that a person is not included in the captured image, the selection unit selects any of the first classification and the second classification on the basis of the track record of the first advertisement, the track record of the second advertisement, the first reference value, and the second reference value.

10. The information processing device according to claim 9, wherein, in a case that a person is not included in the captured image,
the selection unit selects the first classification in a case that a difference between the track record of the first advertisement and the first reference value is less than a difference between the track record of the second advertisement and the second reference value, and
the selection unit selects the second classification in a case that the difference between the track record of the first advertisement and the first reference value is equal to or greater than the difference between the track record of the second advertisement and the second reference value.

11. An information processing device comprising:
an acquisition unit that acquires a captured image obtained by capturing an image of an image capturing region including a position at which a display screen of a display device is visible;
a storage unit that stores a plurality of reference values associated with a plurality of classifications determined in advance for an attribute of a viewer of an advertisement displayed on the display screen;
a determination unit that determines which of the plurality of classifications an attribute of a person included in the captured image falls under;
a selection unit that selects any of the plurality of classifications on the basis of at least track record of the advertisement displayed on the display screen and a determination result of the determination unit; and
a display control unit that causes the display screen to display the advertisement associated with the classification selected by the selection unit,
wherein, in a case that at least a first person is included in the captured image, the selection unit selects any of the plurality of classifications in accordance with different conditions depending on whether a person other than the first person is included in the captured image when the track record of the advertisement displayed on the display screen associated with a first classification determined by the determination unit with respect to an attribute of the first person exceeds a first reference value which is the reference value associated with the first classification.

12. The information processing device according to claim 11, wherein, in a case that a person other than the first person is not included in the captured image, the selection unit selects the first classification even if the track record of the advertisement displayed on the display screen associated with the first classification exceeds the first reference value.

13. The information processing device according to claim 11, wherein, in a case that a second person is included in the captured image together with the first person and the track record of the advertisement displayed on the display screen associated with the first classification determined by the determination unit with respect to the attribute of the first person exceeds the first reference value associated with the first classification, the selection unit determines whether track record of a second advertisement which is the advertisement associated with a second classification determined by the determination unit with respect to an attribute of the second person does not exceed a second reference value which is the reference value associated with the second classification, and selects any of the plurality of classifications in accordance with a result of the determination.

14. An information processing method comprising:
an acquisition step of acquiring a captured image obtained by capturing an image of an image capturing region including a position at which a display screen of a display device is visible;
a determination unit determining which of a plurality of classifications determined in advance an attribute of a person included in the captured image falls under, for an attribute of a viewer of an advertisement displayed on the display screen;
a selection step of selecting any of the plurality of classifications on the basis of at least track record of the advertisement displayed on the display screen and a determination result of the determination unit; and
a display control step of causing the display screen to display the advertisement associated with the classification selected in the selection step,
wherein, in a case that at least a first person and a second person are included in the captured image, the selection step includes selecting a second classification when performing
a first determination that involves determining that track record of a first advertisement which is the advertisement associated with a first classification determined by the determination unit with respect to an attribute of the first person exceeds a first reference value which is the reference value associated with the first classification among reference values associated with each of the plurality of classifications, and
a second determination that involves determining that track record of a second advertisement which is the advertisement associated with the second classification determined by the determination unit with respect to an attribute of the second person does not exceed a second reference value which is the reference value associated with the second classification.
